(19) United States
(12) Patent Application Publication
(10) Pub. No.: US 2026/0148874 A1
(43) Pub. Date: May 28, 2026

(54) AI GOVERNANCE AND TRUST ATTRIBUTION FOR FUSION ENERGY CONTROL SYSTEMS

(71) Applicant: George William Bickerstaff, III, Greenwich, CT (US)

(72) Inventor: George William Bickerstaff, III, Greenwich, CT (US)

(21) Appl. No.: 19/453,247

(22) Filed: Jan. 20, 2026

(51) Int. Cl. G21D 3/00; G05B 13/02; G21B 1/11; G21D 3/04

(52) U.S. Cl. CPC G21D 3/001; G05B 13/028; G21B 1/11; G21D 3/04

(57) ABSTRACT

A governance system for artificial-intelligence-driven fusion energy control assigns trust-weighted authority to autonomous decisions, correlates operational outcomes to control actions, and enables automated rollback. The system generates immutable governance records suitable for regulatory, insurance, and grid-scale deployment of fusion energy systems.

### TECHNICAL FIELD

The present invention relates to artificial intelligence governance and autonomous control of energy infrastructure and, more particularly, to systems and methods for attributing trust, accountability, and outcome responsibility in artificial-intelligence-driven fusion energy control systems.

### BACKGROUND

Fusion energy systems require continuous, real-time control of plasma confinement, magnetic field modulation, thermal stability, component protection, and energy output optimization. These control functions increasingly rely on artificial intelligence systems capable of autonomous or semi-autonomous decision-making.

Existing fusion control architectures are primarily designed to optimize performance and enforce physical safety constraints but do not provide deterministic mechanisms for attributing responsibility, trustworthiness, or accountability to decisions initiated or executed by artificial intelligence systems.

The absence of machine-verifiable accountability frameworks creates regulatory uncertainty, complicates insurance underwriting, and increases operational risk for commercial fusion deployment. Manual reconstruction of autonomous decisions after incidents is insufficient for safety-critical energy infrastructure.

Accordingly, there exists a need for a technical governance system that embeds trust attribution, outcome accountability, and automated rollback directly into artificial-intelligence-driven fusion control pathways.

### SUMMARY OF THE INVENTION

The invention provides an artificial intelligence governance and trust attribution system for fusion energy control environments that assigns trust-weighted authority to autonomous control decisions and deterministically attributes operational outcomes to initiating actions.

The system captures decision intent, execution context, and operational authority prior to execution, correlates these inputs with plasma stability, safety margins, and energy yield outcomes, and generates immutable governance records.

By integrating accountability, trust scoring, and rollback mechanisms into fusion control loops, the invention enables safe, auditable, and regulator-grade deployment of fusion energy systems.

### DEFINITIONS (ALPHABETICAL)

Accountable Controller: An artificial intelligence system or human entity assigned responsibility for a fusion control action.

Action Outcome: A measurable operational result including plasma stability, safety margin, or energy yield.

Coalition Authority: Governance authority shared among operators, regulators, insurers, or grid entities.

Execution Context: Operational conditions and sensor states present at the time of a control decision.

Fusion Control Action: An AI-initiated modification to reactor parameters or operational states.

Governance Ledger: An immutable, cryptographically protected record of trust and accountability events.

Outcome Attribution: Deterministic correlation of operational results to initiating control actions.

Quantum-Resistant Provenance: Cryptographic records designed to remain secure against quantum computing attacks.

Rollback State: A previously validated configuration used to restore safe reactor operation.

Trust Score: A quantified confidence metric assigned to a control decision based on validation signals.

### BRIEF DESCRIPTION OF THE DRAWINGS

FIG. 1 illustrates intent and authority capture for fusion control actions.

FIG. 2 illustrates execution monitoring and plasma outcome correlation.

FIG. 3 illustrates trust scoring and outcome attribution processing.

FIG. 4 illustrates automated rollback and safety enforcement.

FIG. 5 illustrates regulatory, insurance, and grid integration.

### DETAILED DESCRIPTION OF THE INVENTION

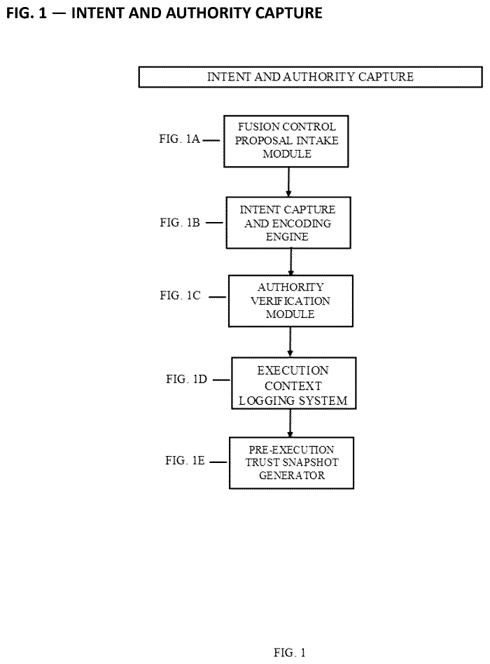

### FIG. 1—Intent and Authority Capture

FIG. 1A illustrates a fusion control proposal intake module in which an artificial intelligence controller submits a proposed control action specifying target plasma parameters, timing constraints, and optimization objectives. Metadata identifying the originating model and confidence interval is included. Registration occurs prior to execution.

FIG. 1B illustrates an intent capture engine that encodes the optimization objective of the proposed control action, including tradeoffs between energy yield, plasma stability, and component longevity. The encoded intent is cryptographically bound to the proposal. This binding prevents post-execution alteration.

FIG. 1C illustrates an authority verification module that validates whether the proposing controller is permitted to act under current operational and regulatory conditions. Authority may derive from operator policy, regulator-approved autonomy thresholds, or coalition governance agreements. Invalid authority results in rejection.

FIG. 1D illustrates an execution context logger that records plasma diagnostics, magnetic field states, thermal loads, and sensor confidence levels at the moment of decision. Context data is timestamped and synchronized. This preserves the operational environment.

FIG. 1E illustrates a pre-execution trust snapshot aggregating intent, authority, and execution context into an immutable governance record. The snapshot is sealed into the governance ledger prior to execution.

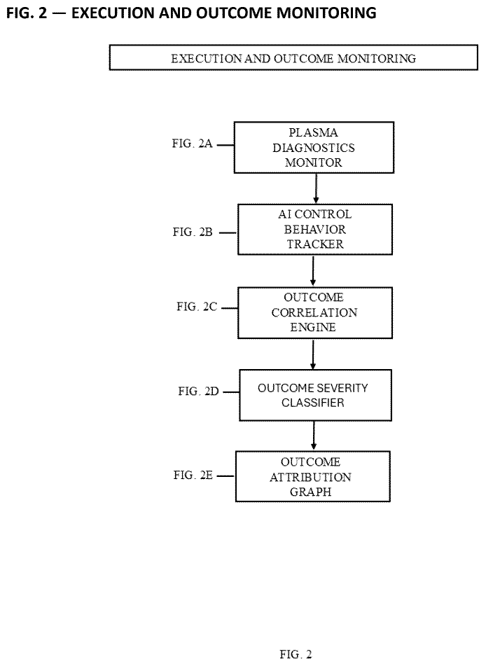

### FIG. 2—Execution and Outcome Monitoring

FIG. 2A illustrates a plasma diagnostics monitor observing confinement stability, turbulence indicators, and energy flux. Diagnostic streams are aligned with control actions. Deviations are detected in real time.

FIG. 2B illustrates an AI behavior tracker evaluating whether control execution adheres to expected response patterns and safety envelopes. Deviations are quantitatively scored. Trust scores are dynamically adjusted.

FIG. 2C illustrates an outcome correlation engine mapping observed plasma behavior and energy yield to initiating control actions and model states. Correlation is computed deterministically. This enables explainable attribution.

FIG. 2D illustrates an outcome severity classifier evaluating whether observed effects exceed predefined safety or regulatory thresholds. Severity determines escalation or rollback. Classification is logged immutably.

FIG. 2E illustrates an outcome attribution graph linking control actions, agents, sensor inputs, and resulting effects. The graph supports root-cause analysis and responsibility assignment.

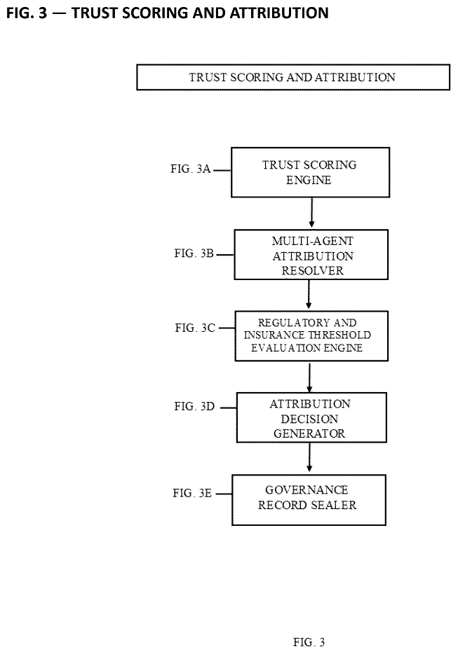

### FIG. 3—Trust Scoring and Attribution

FIG. 3A illustrates a trust scoring engine computing confidence values using historical performance, outcome variance, and cross-sensor corroboration. Scores evolve across operating cycles. Persistent degradation reduces autonomy.

FIG. 3B illustrates a multi-agent attribution resolver allocating responsibility across multiple controllers or authorities. Allocation reflects degree of control and delegation. Shared responsibility is quantified.

FIG. 3C illustrates threshold evaluation against regulator- and insurer-defined criteria. Threshold violations generate compliance events. Events are auditable.

FIG. 3D illustrates attribution decision generation producing machine-readable determinations with supporting rationale. Determinations are reproducible and explainable.

FIG. 3E illustrates a governance record sealer cryptographically protecting attribution outcomes. Records are time-stamped and tamper-evident.

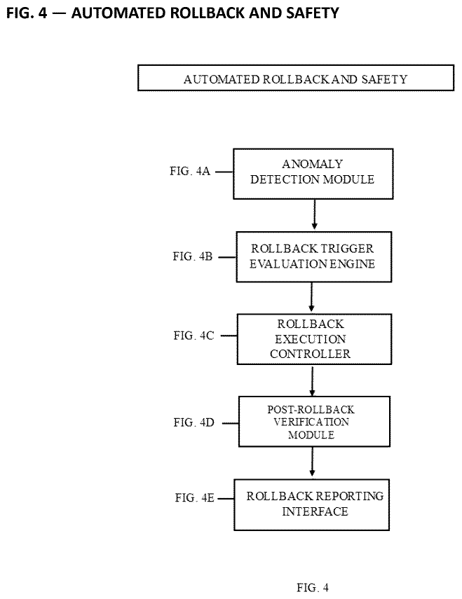

### FIG. 4—Automated Rollback and Safety

FIG. 4A illustrates anomaly detection identifying unsafe plasma dynamics or model instability. Detection uses absolute and trend-based thresholds. Alerts propagate immediately.

FIG. 4B illustrates rollback trigger evaluation comparing trust degradation, anomaly severity, and safety margins. Rollback criteria are deterministic and regulator-approved.

FIG. 4C illustrates rollback execution restoring a previously validated configuration. Restoration includes control parameters and safety constraints. Execution latency is minimized.

FIG. 4D illustrates post-rollback verification confirming stabilization and compliance. Verification outcomes update trust models.

FIG. 4E illustrates standardized rollback reporting to regulators and insurers. Reports include causality and response metrics.

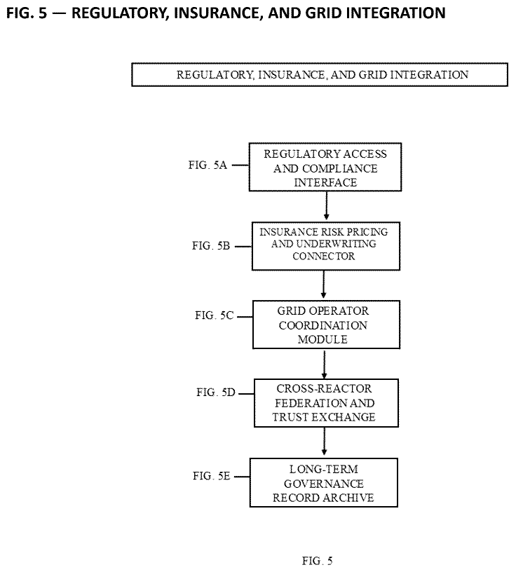

### FIG. 5—External Integration

FIG. 5A illustrates a regulatory interface providing authorized access to governance records. Access is permissioned and logged.

FIG. 5B illustrates insurance integration enabling dynamic risk pricing based on trust and outcome history. Attribution data informs underwriting.

FIG. 5C illustrates grid operator coordination optimizing energy distribution using trusted fusion outputs. Coalition governance enforces allocation policies.

FIG. 5D illustrates cross-reactor federation enabling shared learning using trust metrics rather than raw data. Proprietary information is protected.

FIG. 5E illustrates long-term archival for regulatory and legal purposes. Retention policies comply with jurisdictional requirements.

### Example Embodiments

Example Embodiment I: An artificial intelligence controller proposes a magnetic confinement adjustment during peak load conditions. Trust scoring detects reduced confidence due to sensor divergence and triggers rollback to a validated configuration. The event is immutably recorded and reported.

Example Embodiment II: In a commercial fusion facility responding to grid demand surge, an artificial intelligence controller proposes an aggressive yield optimization. Early instability reduces trust below insurer-defined thresholds, triggering automated rollback prior to safety margin violation. Grid stability and regulatory compliance are preserved without human intervention.

1. An artificial intelligence governance system for fusion energy control, comprising:
an intent capture engine configured to record a purpose associated with a fusion control action;
a trust scoring engine configured to assign confidence values to the fusion control action;
an outcome attribution module configured to correlate operational outcomes to the fusion control action; and
a rollback controller configured to restore a validated prior operational state based on trust degradation or safety thresholds.

2. A method for governing artificial-intelligence-driven fusion control actions, comprising:
capturing intent and execution context prior to execution;
executing a fusion control action based on a trust score;
monitoring operational outcomes;
attributing the operational outcomes to the fusion control action; and
recording a governance record in an immutable ledger.

3. A non-transitory computer-readable medium storing instructions that, when executed by a processor, cause the processor to implement trust attribution and automated rollback for fusion energy control systems.

4. The system of claim 1, wherein the trust score evolves based on historical operational outcomes.

5. The method of claim 2, wherein rollback is triggered automatically upon trust score degradation.

6. The system of claim 1, further comprising a regulatory reporting interface.

7. The method of claim 2, wherein outcome attribution is coalition-based.

8. The system of claim 1, wherein provenance records are quantum-resistant.

9. The computer-readable medium of claim 3, wherein governance records are immutable.

10. The system of claim 1, wherein insurance systems consume attribution data.
